(19) United States
(12) Patent Application Publication
(10) Pub. No.: US 2003/0220818 A1
(43) Pub. Date: Nov. 27, 2003

(54) System and method for creating an appointment card for personal services

(76) Inventor: Marc S. Lemchen, New York, NY (US)

Correspondence Address: Daniel L. Dawes, Myers Dawes Andras & Sherman LLP, Suite 1150, 19900 MacArthur Blvd, Irvine, CA, 92612, US

(21) Appl. No.: 10/441,805

(22) Filed: May 19, 2003

Related U.S. Application Data
(60) Provisional application No. 60/381,143, filed on May 17, 2002.

(51) Int. Cl. G06F 17/60

(52) U.S. Cl. 705/2

(57) ABSTRACT

A method for producing appointment cards comprises the steps of selecting one of a plurality of patient management systems in which data retrieval is to occur. Data is retrieved according to the format assumed in the database of that selected patient management system. Both text and/or image data on the appointment card corresponding to the corresponding patient, such as image data of the corresponding patient relating to the treatment received by or to be received by the patient like dental images relating to orthodontic improvement in the patient. Selected advertisements as controlled from a remote server on the internet are printed onto the card as determined by a remote advertising sales manager or advertising schedule, selected according to patient data criteria communicated to the server, including biographical, geographic and treatment information uploaded to the server.

### RELATED APPLICATIONS

The present application is related to U.S. Provisional Patent Application serial No. 60/381,143, filed on May 17, 2002, which is incorporated herein by reference and to which priority is claimed pursuant to 35 USC 119.

### BACKGROUND OF THE INVENTION

1. Field of the Invention

The invention relates to the field of computer-based systems for retrieving and processing data, and more specifically, to a computer system that accesses appointment data and creates an appointment for a medical card therefrom for a medical service provider.

2. Description of the Prior Art

It is known in the art to access data on a computer system in a doctor's office in order to create an appointment card for reminding a patient of a forthcoming appointment. The use of the Internet to notify patients of their upcoming appointments is also known. This is accomplished by sending e-mail reminders to the patients. Of course, postcards have also been utilized. Postcards are generally sent by regular mail service.

The prior art has failed to provide an automated system that interfaces with a wide variety of practice management programs in order to access appointment data, patient data, and/or images. The prior art has failed to provide advertisement data via the Internet to be retrieved from a remote site. The prior art is deficient in providing a systematic method and means for updating advertisement data to be printed on an appointment card in accordance with a preprogrammed set of criteria. The prior art has not adequately shown or put into practice a method for identifying a patient and/or their health condition on an appointment card.

### BRIEF SUMMARY OF THE INVENTION

The invention comprises an Internet based computer controlled system for accessing appointment data from any of the broad variety of practice management programs. Alternatively, the computer system need not be Internet based, but should at least enable access to data over the Internet. A software program to control the system can be downloaded from a remote server, or may be installed directly from a storage media onto a user's computer. The system software of the invention has means for interfacing with a wide variety of practice management programs in order to find a path to appointment data bases and other customer data. In conjunction with this means for interfacing, the system software may be configured to prompt a user for the specific practice management program being used on a local computer or network.

The system software of the invention also has a means for packaging data retrieved for subsequent printing in a predetermined format on an appointment card. Of course, the software provides user interface means for selecting a particular patient and the data that is desired for the appointment card. Likewise, the software includes a user interface means for causing an appointment card to be printed. The system also includes a printer, (preferably of high-quality), that receives a command under software control and prints out a reminder on the appointment card in response thereto. The system software also permits a user to selectively print out an image of a patient and/or an image of the subject matter of the customer's appointment, (i.e., for example, a picture of a dental patient's teeth).

Additionally the system further has a means for accessing advertising data from a remote server such as on the Internet. In this way, an advertisement may be included on the appointment card. While the advertisement could be positioned anywhere on the card, it is contemplated that the entire backside of the card could be used for advertising. The advantage of accessing advertisement data from a server over the Internet is that the advertisement can be changed periodically and managed for good advertisement coverage. The advantage of including advertising is that the cost of the system can be offset by payments from companies whose products and/or services are being advertised. The system software is configured to determine which of a plurality of advertisements is to be printed on the card in accordance with a predetermined period of time for advertising, or according to a predetermined number of cards to be produced with a particular advertisement.

The invention is also embodied in the method of accessing appointment data from a doctor's office database. It is contemplated that this method may be equally useful for doctors, dentists, orthodontists, or any other business that provides services by appointment. The method includes accessing appointment data, patient identification data (including image), and advertising data. Images may include a customer's face for more certain identification when creating and distributing the appointment card. The images may also include subject matter related to the purpose for which the appointment has been made. For example, the method applied in a dental or an orthodontics office may include a picture of the patient's teeth before treatment. Such an image can serve as a reminder of the improved appearance that has been achieved through treatment. It is intended that accessing the data will be accomplished by software program control.

Also by the system program, an existing practice management program on the user's computer or local network is engaged and manipulated in order to open a path for data from patient's databases. In conjunction with this step, the invention's system program is configured to prompt a user for input of a particular practice management program. The input from the user's response enables the program to match with and properly interface with the particular practice management program in order to retrieved data that is regularly handled by the practice management program.

The method also includes: retrieving and packaging the data in a format to be printed; and printing an appointment card having appointment data, patient related images, and advertisement images; all under software program control. The invention also includes or may be considered as a method of creating an appointment card. The method defined thus, generally includes some or all of the steps of the method of accessing appointment data.

The invention also includes a method of advertising products and services. Of particular interest is the advertisement of health-care products and services. The method of advertising of the invention Includes preparing an appointment card having an advertisement thereon. Preferably the advertisement is placed on the backside of the appointment card. Of particular interest is the accomplishment of this step automatically under software program control. In this regard, the method includes determining which of a plurality of advertisements is to be placed on the appointment card. This is accomplished by a preprogrammed means for selecting a particular advertisement. The program thus selects the particular advertisement based on a predetermined set of criteria. For example, the advertisement may be selected in accordance with the date on which the advertisement data is being retrieved. That is, a certain advertisement may have a certain period during which it is being run. Alternatively, the system program of the invention may select a particular advertisement in accordance with a predetermined number of appointment cards that are to be created with that particular advertisement. Other selection criteria may include matching a particular advertisement to a type of service being provided. Alternatively, advertisement selection could entail matching a particular advertisement to predicted patient interests or needs based on customer data including age, gender, and nature of treatment.

The method includes providing the advertisement data from a remote site such as from a server on the Internet. In this way, the advertisement data can be updated periodically and is totally within the control of an advertisement management entity. Providing advertisements on appointment cards adds a peripheral aspect to the methods of the invention. That is, the costs of the system including the printer can be defrayed by payments from companies whose products and services are being advertised.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a diagrammatic depiction showing the hardware elements of a user computer for the system and method of the invention.

FIG. 2 is a block diagram showing the various modules of the software program of the invention.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

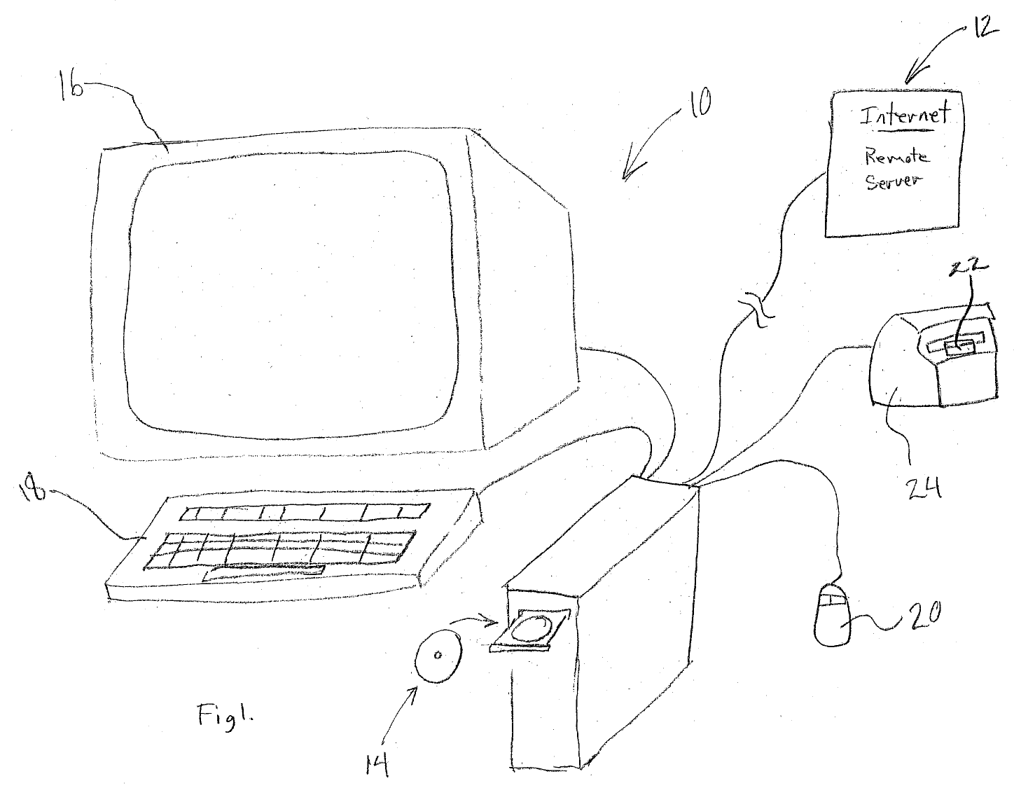

As shown in FIG. 1 the invention is implemented on a user's computer 10. Computer 10 may be a stand-alone personal computer or may be part of a local computer network. However, computer 10 is advantageously connected through conventional means to the Internet 12 and therefore has access to remote servers also connected to the Internet. Software 14 for implementing the invention may be stored on conventional storage media such as a CD. Alternatively the software 14 may be downloaded from a remote site over the Internet. Monitor 16, keyboard 18, and mouse 20 enable a user interface with the software program of the invention. Certain displays and prompts are provided on the monitor 16 to enable the accessing, retrieving, compiling, formatting, and printing of data and images on an appointment card 22. A high-quality or laser printer 24 is also connected to the system for the purpose of printing the appointment cards 22.

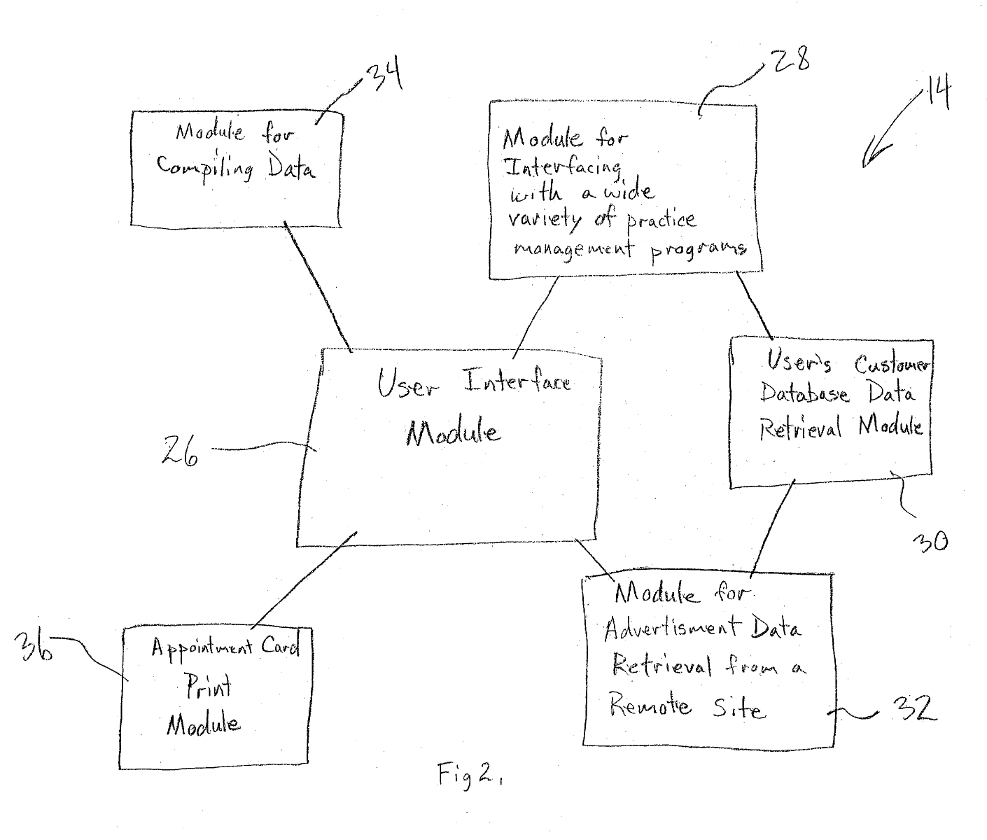

FIG. 2 is a block diagram representing the various modules that make up the software program. An interface module 26 provides displays and prompts on the screen of the user's monitor 16. One of the prompts that displayed when starting the program is for user to input or select a specific practice management program being used on his or her computer or local network. A practice management module 28 for interfacing with a wide variety of practice management programs matches the user's input with programming specific to that particular practice management program to enable the accessing of data regularly handled by the selected practice management program. The specific programming matched to the user's input enables access and retrieval of customer or patient data and related patient or other images from databases stored locally or on a remote server by a data retrieval module 30.

An advertisement module 32 for retrieving advertisement data from a remote site is also included in the software 14. This module enables retrieval of advertisement data and images and automatically selects an advertisement from among a plurality of advertisements available depending on a predetermined set of criteria.

Software 14 also includes a data/formatting module 34 for compiling the data and images to be printed on the appointment card 22. The data/formatting module 34 compiles and formats the data and images for aesthetic presentation on the appointment card 22.

The software 14 also includes a printing module 36 for printing the appointment card 22. The printing module 36 may enable user adjustment of settings for different print options and/or formats. It is to be understood that the printer 24 may be a printer that is manufactured specifically for this or similar applications of printing cards, or may be an off-the-shelf printer. In either case, printer 24 is to be of high quality and may have the capability of automatically printing on both sides of the advertisement card.

In summary, it is to be understood that the invention includes a method for managing personal service appointment cards from a plurality of patient management systems comprising the steps of selecting one of the plurality of patient management systems in which data retrieval is to occur. Doctor's offices typically run their appointment schedules using one of a plurality of commercially available patient appointment and billing systems. The invention is adapted to be able to interface with anyone of a plurality of the databases which such appointment and billing systems compile. Once the patient management system is selected data is retrieved according to the format assumed in the database of that selected patient management system. Appointment and patient data is printed for at least one appointment card using the retrieved data corresponding to at least one patient. Typically, such information includes as a minimum the patient's name and address on one side of the card and the date and time of the appointment on the other. Also included on both or either side of the card are the return address and other information pertaining to the service provided or the services provided. For example, a message personalized to the patient or the patient's treatment can be included, such as “Mr. Jones, this is your 6 month follow-up for teeth cleaning. A biannual x-ray of your teeth for detection and prevention of cavities will also be taken.” The printer used to print the cards may be generically or specially built and designed just to print the appointment cards. Thus, in one embodiment the user selected information on both sides of the appointment card simultaneously.

Both text and/or image data on the appointment card corresponding to the corresponding patient, such as image data of the corresponding patient relating to the treatment received by or to be received by the patient like dental images relating to orthodontic improvement in the patient. Before and after photos of the teeth alignments may be printed or dental images relating to cosmetic improvement in the dental appearance of the patient.

In addition to patient data the appointment card may be printed with selected advertisements as controlled from a remote server on the internet as determined by a remote advertising sales manager or advertising schedule, e.g. number of impressions and geographic distributions. For example, the advertisements may be selected according to patient data criteria communicated to the server, which includes not only biographical information about the patient but also geographic location of the patient's residence and patient treatment information uploaded to the server. For example, if the patient has been receiving teeth whitening or bleaching treatments, advertisements for tooth whitening dentifrices can be selected and printed.

The invention is also an apparatus for managing personal service appointment cards from a plurality of patient management systems comprising a user database compiled in one of the plurality of patient management systems; a means for selecting one of the plurality of patient management systems in which data retrieval is to occur; a means for retrieving data from the user database in the selected patient management system communicated with the means for selecting one of the plurality of patient management systems; and a means for printing at least one appointment card using the retrieved data corresponding to at least one patient corresponding to the retrieved data, the means for printing communicated with the means for retrieving data. The various means preferably comprise a software controlled computer system. The means for selecting one of the plurality of patient management systems in which data retrieval is to occur comprises a user interface software module and a program management software module intercommunicated to the user interface software module. The apparatus further comprises an advertisement software module intercommunicated to the user interface software module for providing selected advertisements to be printed on the appointment cards.

The apparatus further comprises a remote server intercommunicated to the advertisement module, such as an internet connected advertising sales manager. The remote server manages the type and frequency of advertisements printed onto the appointment cards according to a predetermined advertising schedule; selects the advertisements printed onto the appointment cards according to patient data uploaded from the user's database to the server; selects the advertisements printed onto the appointment cards according to patient data uploaded from the user's database to the server; and/or selects the advertisements printed onto the appointment cards according to patient treatment data uploaded from the user's database to the server.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

I claim:

1. A method for managing personal service appointment cards from a plurality of patient management systems comprising:
selecting one of the plurality of patient management systems in which data retrieval is to occur;
retrieving data from a user database in the selected patient management system; and
printing at least one appointment card using the retrieved data corresponding to at least one patient corresponding to the retrieved data.

2. The method of claim 1 where printing at least one appointment card is performed using a printer which is particularly arranged and configured to print appointment cards.

3. The method of claim 2 where printing at least one appointment card prints user selected information on both sides of the appointment card.

4. The method of claim 1 where printing at least one appointment card prints text and/or image data on the appointment card corresponding to the corresponding patient.

5. The method of claim 4 where printing text and/or image data on the appointment card corresponding to the corresponding patient comprises printing image data of the corresponding patient relating to the treatment received by or to be received by the patient.

6. The method of claim 5 where printing image data of the corresponding patient relating to the treatment received by or to be received by the patient comprises printing dental images relating to orthodontic improvement in the patient.

7. The method of claim 5 where printing image data of the corresponding patient relating to the treatment received by or to be received by the patient comprises printing dental images relating to cosmetic improvement in the dental appearance of the patient.

8. The method of claim 1 where printing at least one appointment card comprises printing selected advertisement on the appointment card.

9. The method of claim 8 where printing selected advertisement on the appointment card comprises selecting advertisement for printing from a server on the internet as determined by a remote advertising sales manager.

10. The method of claim 9 where selecting advertisement for printing from a server on the internet as determined by a remote advertising sales manager comprises selecting advertisement based on patient data criteria communicated to the server for each corresponding patient's appointment card.

11. The method of claim 10 where selecting advertisement based on patient data criteria communicated to the server for each corresponding patient's appointment card comprises selecting advertisement based on patient biographical information uploaded to the server.

12. The method of claim 10 where selecting advertisement based on patient data criteria communicated to the server for each corresponding patient's appointment card comprises selecting advertisement based on patient treatment information uploaded to the server.

13. An apparatus for managing personal service appointment cards from a plurality of patient management systems comprising:
a user database compiled in one of the plurality of patient management systems;
means for selecting one of the plurality of patient management systems in which data retrieval is to occur;
means for retrieving data from the user database in the selected patient management system communicated with the means for selecting one of the plurality of patient management systems; and
means for printing at least one appointment card using the retrieved data corresponding to at least one patient corresponding to the retrieved data, the means for printing communicated with the means for retrieving data.

14. The apparatus of claim 13 where the means for selecting one of the plurality of patient management systems in which data retrieval is to occur comprises a user interface module and a program management module intercommunicated to the user interface module.

15. The apparatus of claim 13 further comprising an advertisement module intercommunicated to the user interface module for providing selected advertisements to be printed on the appointment cards.

16. The apparatus of claim 15 further comprising a remote server intercommunicated to the advertisement module.

17. The apparatus of claim 16 where the remote server manages the type and frequency of advertisements printed onto the appointment cards according to a predetermined advertising schedule.

18. The apparatus of claim 16 where the remote server selects the advertisements printed onto the appointment cards according to patient data uploaded from the user's database to the server.

19. The apparatus of claim 17 where the remote server selects the advertisements printed onto the appointment cards according to patient data uploaded from the user's database to the server.

20. The apparatus of claim 16 where the remote server selects the advertisements printed onto the appointment cards according to patient treatment data uploaded from the user's database to the server.
